(19) United States
(12) Patent Application Publication
(10) Pub. No.: US 2021/0160076 A1
(43) Pub. Date: May 27, 2021

(54) SYSTEM AND METHOD FOR SECURE BIOMETRIC AUTHENTICATION

(71) Applicant: REDROCK BIOMETRICS INC, San Francisco, CA (US)

(72) Inventors: Hua YANG, Millbrae, CA (US); Leonid KONTSEVICH, San Francisco, CA (US); Kevin HOROWITZ, Sherman Oaks, CA (US)

(21) Appl. No.: 16/954,179

(22) PCT Filed: Dec. 14, 2018
(86) PCT No.: PCT/CN2018/121086

§ 371 Date: Jun. 15, 2020

(30) Foreign Application Priority Data
Dec. 14, 2017 (CN) 201711341533.6
Dec. 13, 2018 (CN) 201811528719.7

(51) Int. Cl. H04L 9/32; H04L 9/08; H04L 29/06; G06Q 20/40; G06Q 20/38

(52) U.S. Cl. CPC H04L 9/3231; H04L 9/0894; G06Q 2220/00; G06Q 20/40145; G06Q 20/3829; H04L 63/0442

(57) ABSTRACT

The invention presents a biometric authentication system comprising: a template module and a key module that are independent of each other. The template module is used to store encrypted biometric templates, the key module is used to store the decryption keys. The system may further comprise a matching module that acquires the decryption key from the key module and the encrypted template from the template module, decrypts the template using the key, then matches the template to verify the identity. In this system, the encrypted template and decryption key are stored separately both logically and physically, and are only united momentarily during matching, then are immediately deleted. The system is highly secure and addresses the security vulnerabilities in the current banking and payment systems, both online and offline such as ATM machines.

### TECHNICAL FIELD

The present disclosure relates in general to biometric authentication, and in particular to the data security of a biometric authentication system.

### BACKGROUND

As biometric technologies continue to develop, people have started applying biometrics to financial applications such as banking and mobile payments etc. Through secure communications among mobile phones, banks, and merchants, biometrics is used to verify identities and authorize online transactions. However, despite the use of cryptography in the communication of the state of the art online and offline banking and payment systems such as ATMs, information of the users can still be comprised due to certain data security vulnerabilities.

Biometric identification/authentication systems work by comparing a biometric template stored during user registration with a biometric scan captured during user authentication. If the two matches, the identity of the user is verified. Regarding the storage of the biometrics templates, there are three main categories of storages methods:

Stored in a portable token: biometric templates can be stored in a portable token or smart card such as ID cards, bank cards, etc. This type of storage medium of biometric templates is highly secure as the storage chips of the smart cards are usually read-only and hardware encrypted. However, this approach bears a high cost due to the production and distribution of smart cards. Moreover, smart cards require special card readers to be read. This requirement further limits the wide adoption of this biometric storage approach.

Stored on the server: biometric templates can be stored in a central repository on a networked server. The advantage of this method is that user identity verification can be performed on any terminal device connected to the server. However, the server node storing the biometric templates can become a focal point for hackers to attack. Once the server is comprised, a large number of biometric data will be stolen, which can cause a serious breach of the privacy agreement.

Stored in personal devices: biometric templates can be stored in the users' personal devices. Unlike tokens or smart cards, personal devices usually have various built-in communication modules that can connect to servers or terminal devices through a network or near-field communication (NFC). In addition, the distributed storage of biometric templates reduces the risk of hacker attacks. However, a personal device is easier to steal and in general less secure than a server workstation.

Biometric authentication has already been applied to payment systems. For example, CN201510063624.2 discloses a payment method and system that combines Bluetooth technology and biometrics. Bluetooth is used to speed up matching by reducing the search space within the user database. Cryptography is used to transfer the biometric template securely. However, the proposed method attempts to match the newly captured biometric scan with previously registered templates of all potential payers. Moreover, the registered templates are stored on the server unencrypted which may cause serious data breach. Similarly, CN107196765A discloses a remote biometric authentication method that adopts biometric template encryption to enhance the security in the data transmission process.

To address the shortcomings and deficiencies of the prior art, a new biometric authentication system is developed. Biometric templates are only stored in the encrypted format. Moreover, the encrypted templates and the decryption keys are stored separately during the registration and most of the authentication procedures, and are only united momentarily during matching, and are cleaned immediately after that. The new solution addresses security vulnerabilities in the existing banking and payment systems, both online and offline such as ATM machines.

### SUMMARY

This invention discloses a biometric authentication system, comprising a template module and a key module that are independent of each other. The template module stores encrypted biometric templates generated by encrypting biometric templates using encryption keys. The key module stores the decryption keys that can be used to decrypt the encrypted templates.

In a preferred embodiment, the template module is a personal device or a server, accordingly, the key module is the other device of the personal device and the server.

In another preferred embodiment, the biometric authentication system further comprises a capture module that captures biometric scans. The capture model can be the personal device or a terminal device connected to the server.

In another preferred embodiment, the biometric authentication system further comprises a matching module. The matching module matches previously registered biometric template(s) with a newly captured biometric scan. The matching module acquires the decryption key from the key module and the encrypted template from the template module, then decrypt the encrypted template to recover the original template. The matching module also takes input of the biometric scan from the capture module.

In another preferred embodiment, the matching module is the personal device or the server, or a terminal device connected to the server.

In another preferred embodiment, the capture module and the template module are in the same device, or the capture module and the key module are in the same device.

In another preferred embodiment, the matching module and the template module are in the same device, or the matching module and the key module are in the same device.

In another preferred embodiment, the matching module and the capture module are in the same device.

The second aspect of this invention presents a biometric authentication method that can be applied to the biometric authentication system disclosed in the first aspect of this invention, whose registration procedure comprises steps as follows:

(1) The template module establishes a connection to the key module. A pair of encryption and decryption keys and a unique identification code (UIC) are generated by the template module or the key module.

(2) A biometric template is created and encrypted using the encryption key. The encrypted template corresponds one to one with the UIC.

(3) The encrypted template and the UIC are stored in the template module. The decryption key and the UIC are stored in the key module. All other information is deleted from all modules.

In another preferred embodiment, the UIC is created as a function of the encrypted template such that the encrypted template corresponds one to one with the UIC.

In another preferred embodiment, the UIC is the same as the encryption key.

In another preferred embodiment, the communication among modules is secured using asymmetric encryption.

The third aspect of this invention presents a biometric authentication method that can be applied to the biometric authentication system disclosed in the first aspect of this invention, whose authentication procedure comprises steps as follows:

(a) The capture module, the matching module, the template module and the key module establish connections.

(b) The capture module captures a biometric scan. The template module uses the UIC(s) to locate the to-be-matched encrypted template(s). The key module uses the UIC(s) to locate the decryption key(s) of the to-be-matched encrypted templates.

(c) The matching module acquires the encrypted template, decryption key, and biometric scan from the template module, key module and capture module respectively. The matching module uses the decryption key to decrypt the encrypted template, matches it with the biometric scan, then sends the matching result to the terminal.

(d) When matching is finished, the template module stores the encrypted template and the UIC, the key module stores the decryption key and the UIC. All other information is deleted from all modules.

In another preferred embodiment, the data transmission among different modules is secured using asymmetric encryption.

In another preferred embodiment, the biometric scan captured by the capture module is a biometric image or a biometric encoding.

In another preferred embodiment, the biometrics include one or multiple of: (1) palmprint, (2) face, (3) eye pattern and (4) iris.

The fourth aspect of this invention presents a biometric authentication method that can be applied to the biometric authentication system disclosed in the first aspect of this invention, comprising a user registration procedure that consists of steps as follows:

S171: the key module generates a pair of encryption and decryption keys and a UIC.

S172: the key module sends the UIC to the template module, and sends the encryption key to the capture module directly or through the template module.

S173: the capture module captures a biometric scan and creates a biometric template, then encrypts the template using the encryption key.

S174: the capture module sends the encrypted template to the template module.

S175: the template module stores the UIC and the encrypted template. The key module stores the UIC and the decryption key. All other information is deleted from all modules.

In another preferred embodiment, the capture module and the template module are in the same device.

In another preferred embodiment, the capture module and the key module are in the same device.

The fifth aspect of this invention presents a biometric authentication method that can be applied to the biometric authentication system disclosed in the first aspect of this invention, comprising a user authentication procedure consists of steps as follows:

S201: the personal device sends the UIC to the server. If the template module is in the personal device and the key module is in the server, the UIC is used to locate the decryption key in the server. If the key module is in the personal device and the template module is in the server, the UIC is used to locate the encrypted template in the server.

S202: the template module sends the encrypted template to the matching module. The key module sends the decryption key to the matching module.

S203: the matching module uses the decryption key to decrypt the encrypted template.

S204: the capture module captures a biometric scan and sends it to the matching module.

S205: the matching module performs authentication by matching the decrypted template with the biometric scan.

S206: the matching module sends matching result to the terminal.

S207: the matching module deletes the data received from other modules.

In another preferred embodiment, the capture module is in the same device as the template module or the key module.

In another preferred embodiment, the matching module is in the same device as the template module or the key module.

In another preferred embodiment, the matching module and the capture module are in the same device.

In another preferred embodiment, step 204 further comprises:

S2041: a second pair of encryption and decryption keys is generated for the secure transmission of the captured biometric scan.

S2042: the second encryption key is sent to the capture module and the second decryption key is sent to the matching module.

S2043: the capture module uses the second encryption key to encrypt the biometric scan, then sends the encrypted scan to the matching module.

S2044: the matching module uses the second decryption key to decrypt the encrypted scan to recover the biometric scan.

Preferably, the matching module has a processing unit that can decrypt the encrypted template, perform identity verification through matching the decrypted template with a biometric scan. When matching is finished, the matching module will delete the encrypted template, decrypted template and decryption key from its storage.

Preferably, the capture module is equipped with a biometric sensor such as a camera. The capture module uses the sensor to capture biometric scans as biometric images or encodings. The template module, key module or matching module can become the capture module if it is equipped with biometric sensor hardware.

This invention proposes a system solution for the secure storage of biometric data. Biometric templates are encrypted immediately after being captured and generated, and the encrypted templates and the decryption keys are stored separately, one on the server and the other on the personal device. The encrypted template and the decryption key are only united momentarily when matching is performed upon a request prompted by the user at a terminal connected to the server. When matching is finished, the decryption key and the encrypted and decrypted templates are deleted. In this setup, when the personal device or the server is comprised unilaterally, only the decryption key or the encryption template is stolen, which is not sufficient for the hacker to recover the biometric information of the user.

### BRIEF DESCRIPTION OF THE DRAWINGS

FIG. 1 shows the correspondences between the unique identification code (UIC) and the template, and the encryption and decryption of the biometric template.

FIG. 2 shows the data stored on the personal device and server as well as the communication between the two.

FIG. 3 illustrates the first example of user registration workflow.

FIG. 4 illustrates the second example of user registration workflow.

FIG. 5 illustrates the third example of user registration workflow.

FIG. 6 illustrates the fourth example of user registration workflow.

FIG. 7 illustrates the first example of user authentication workflow.

FIG. 8 illustrates the second example of user authentication workflow.

FIG. 9 illustrates the third example of user authentication workflow.

FIG. 10 illustrates the fourth example of user authentication workflow.

FIG. 11 illustrates the fifth example of user authentication workflow.

FIG. 12 illustrates the sixth example of user authentication workflow.

FIG. 13 illustrates the seventh example of user authentication workflow

FIG. 14 illustrates the eighth example of user authentication workflow.

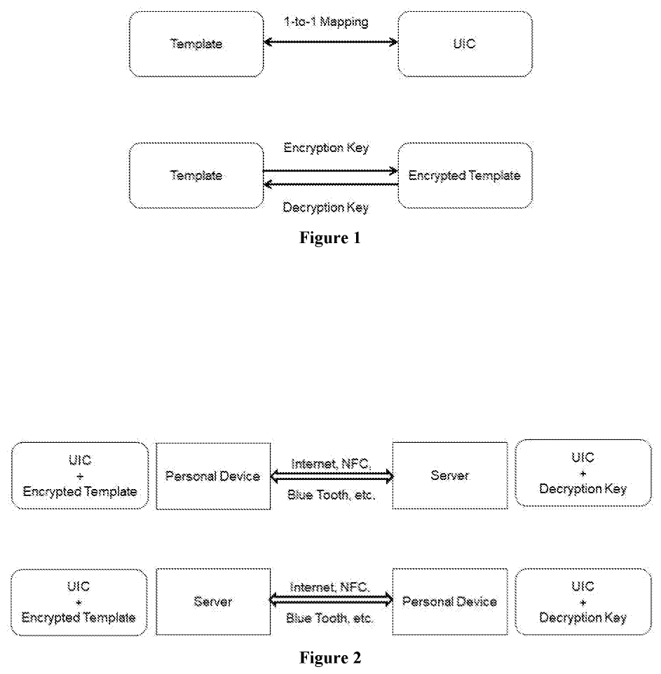

### DETAILED DESCRIPTION OF THE DRAWINGS

### Explanation of Terms

As used in this invention, “biometric template” refers to the biometrics stored during the user registration process, which will be later used to match with newly captured biometrics to verify the user's identity during the authentication process.

As used in this invention, “biometrics” refers to the inherent physiological characteristics of the human body, such as fingerprints, palm prints, irises, facial features, DNA, etc.

As used in this invention, “biometric image” refers to an image or a video containing biometric information that are captured by a camera or an imaging device.

As used in this invention, “biometric encoding” refers to biometric data presented in formats other than biometric images, for instance, as mathematical or computer representations such as vectors and matrices etc. The data may be directly captured or may be computed from biometric images.

As used in this invention, “personal device” can be a personal device owned and/or used by a user including mobile phones, tablets, laptops, PCs, smart watches, etc.

As used in this invention, “server” can be a computer server or a server node that is used by the authentication or payment service provider for storage, communication and/or other services.

As used in this invention, “terminal” can be a terminal device, such as an ATM or self-service counter etc., that is provided and/or set up by the authentication or payment service provider.

As used in this invention, “capture module”, “matching module”, “key module” and “template module” are logical entities defined by their functionalities in the registration and authentication procedures. Physically they can be the personal device, the server or the terminal. The correspondences between the four modules and the three devices can vary across different solutions. In practice, the modules can overlap. For instance, the capture module and matching module can both run on the personal device (as shown in registration workflow example one); and the capture module and matching module can both run on the terminal (as shown in authentication workflow example one). More examples are described in the rest of this article.

As used in this invention, “asymmetric encryption” refers to a class of cryptography wherein the encryption and decryption keys are generated in pairs, and the two keys are different, and the decryption key cannot be derived from the encryption key using an achievable amount of calculation. The data encrypted using the encryption key can be decrypted using the decryption key.

### Implementation Examples

To ensure the security of user's biometric data, the biometric authentication system and method proposed in this invention separate the storage of the encrypted template and the decryption key. One is stored in a personal device such as mobile phones, tablets, laptops, PCs, VR headsets etc.; the other is stored in a server that is connected with one or multiple terminals. In this setup, even when the server is compromised, because the decryption key or the encrypted template is stored in the personal device, the hacker still cannot obtain the original biometric template. There are two specific implementations: (1) storing the decryption key in the personal device and the encrypted template in the server, in this setup, the personal device is the key module and the server is the template module; (2) storing the encrypted template in the personal device and the decryption key in the server, in this setup, the personal device is the template module and the server is the key module. The encryption described above can be an asymmetric encryption.

First, let's go over four example registration workflows:

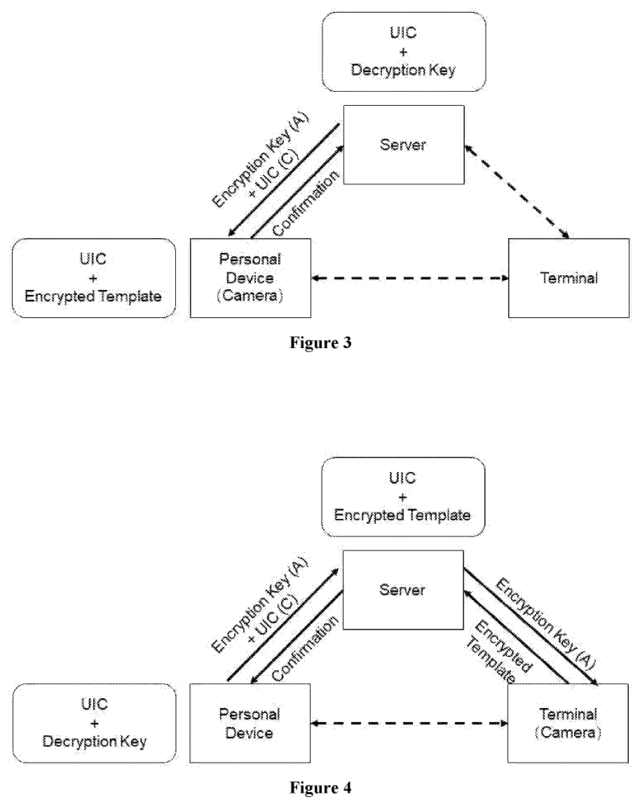

Registration workflow embodiment one, the biometric template is captured using the camera of the personal device, the encrypted template is stored in the personal device, the decryption key is stored in the server. The detailed steps are as follows (FIG. 3):

Step 1: the personal device establishes a connection to the server.

Step 2: the server generates a pair of keys, the encryption key A and decryption key B, and the unique identification code (UIC) C.

Step 3: the server sends the encryption key A and UIC C to the personal device.

Step 4: the user uses the camera of the personal device to capture a biometric scan and create an original template, the template is encrypted using encryption key A.

Step 5: the personal device sends a confirmation to the server

Step 6: the server stores the decryption key B and UIC C.

Step 7: the personal device stores the encrypted template and UIC C, deletes the original template.

In this embodiment, several steps can be replaced as follows: (1) the encryption key can be used as UIC, i.e., A=C; (2) the encryption key, decryption key and UIC can be generated by the personal device and sent to the server; (3) the personal device can be connected directly to the terminal (through NFC for instance) and be connected to the server through the terminal.

In this embodiment, the personal device is the capture module as well as the template module. The server is the key module. Similarly, multiple modules can be in the same device in other embodiments. While the overlapped modules may be different and the mappings between the logical modules and physical devices may change, such variances will not be elaborated in the rest of this article.

Registration workflow embodiment two, the biometric template is captured using the camera of the terminal, the encrypted template is stored in the server, the decryption key is stored in the personal device. The detailed steps are as follows (FIG. 4):

Step 1: the personal device establishes connections to the terminal and server.

Step 2: the personal device generates a pair of keys, the encryption key A and decryption B, and UIC C.

Step 3: the personal device sends the encryption key A and UIC C to the server.

Step 4: the user uses the camera of the terminal to capture a biometric scan and create an original biometric template.

Step 5: the terminal receives the encryption key A from the server, uses A to encrypt the template into an encrypted template and send it to the server.

Step 6: the server sends a confirmation to the personal device.

Step 7: the personal device stores the decryption key B and UIC C.

Step 8: the server stores the encrypted template and UIC C. The terminal deletes the original template.

In this embodiment, several steps can be replaced as follows: (1) the encryption key can be used as UIC, i.e., A=C; (2) the encryption key, decryption key and UIC can be generated by the server and sent to the personal device; (3) the personal device can be connected directly to the terminal (through NFC for instance) and be connected to the server through the terminal; (4) when the communication between the terminal and the server is secure, for instance the two are in the same device or in the same secure intranet, in Step 5 above, the terminal can send the original template to the server and let the server encrypt the template.

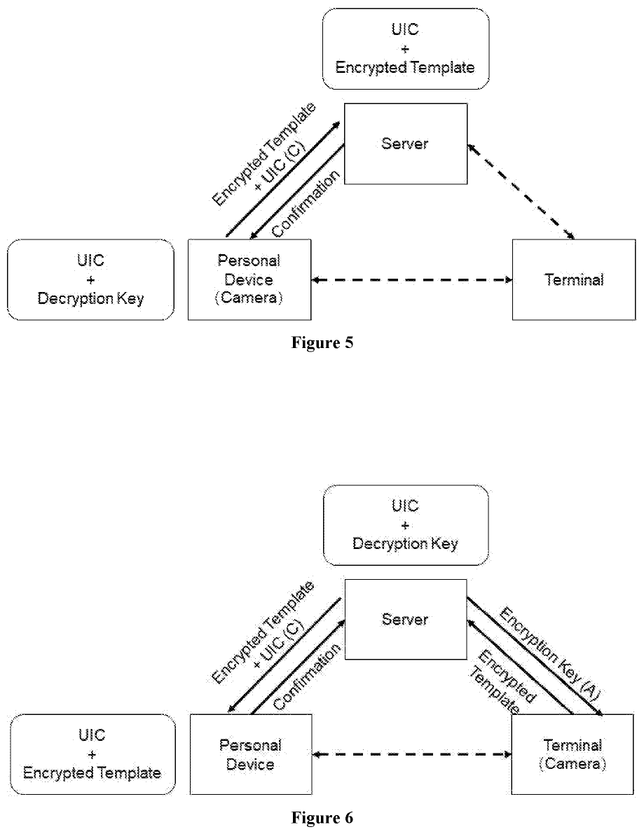

Registration workflow embodiment three, the biometric template is captured using the camera of the personal device, the encrypted template is stored in the server, the decryption key is stored in personal device. The detailed steps are as follows (FIG. 5):

Step 1: the personal device establishes a connection to the server.

Step 2: the personal device generates a pair of keys, the encryption key A and decryption key B, and UIC C.

Step 3: the user uses the camera of the personal device to capture a biometric scan and create an original template.

Step 4: the personal device uses the encryption key A to encrypt the original template, and sends the encrypted template and UIC C to the server.

Step 5: the server sends a confirmation to the personal device.

Step 6: the personal device stores the decryption key B and UIC C, and deletes the original and encrypted templates.

Step 7: the server stores the encrypted template and UIC C.

In this embodiment, several steps can be replaced as follows: (1) the encryption key can be used as UIC, i.e., A=C; (2) the encryption key, decryption key and UIC can be generated by the server and sent to the personal device; (3) the personal device can be connected directly to the terminal (through NFC for instance) and be connected to the server through the terminal.

Registration workflow embodiment four, the biometric template is captured using the camera of the terminal, the encrypted template is stored in the personal device, the decryption key is stored in the server. The detailed steps are as follows (FIG. 6):

Step 1: the personal device establishes connections to the terminal and server.

Step 2: the server generates a pair of keys, the encryption key A and decryption key B, and UIC C.

Step 3: the user uses the camera of the terminal to capture a biometric scan and create an original template.

Step 4: the terminal receives the encryption key A from the server, uses A to encrypt the template into an encrypted template and send it to the server.

Step 5: the server sends the encrypted template and UIC C to the personal device.

Step 6: the personal device sends a confirmation to the server.

Step 7: the server stores the decryption key B and UIC C, and deletes the encrypted templates. The terminal deletes the original template.

Step 8: the personal device stores the encrypted template and UIC C.

In this embodiment, several steps can be replaced as follows: (1) the encryption key can be used as UIC, i.e., A=C; (2) the encryption key, decryption key and UIC can be generated by the personal device and sent to the server; (3) the personal device can be connected directly to the terminal (through NFC for instance) and be connected to the server through the terminal; (4) when the communication between the terminal and the server is secure, for instance the two are in the same device or in the same secure intranet, in Step 4 above, the terminal can send the original template to the server and let the server encrypt the template.

The descriptions so far are on the registration workflow. After the registration is finished, the user can use the biometric authentication system to verify identity.

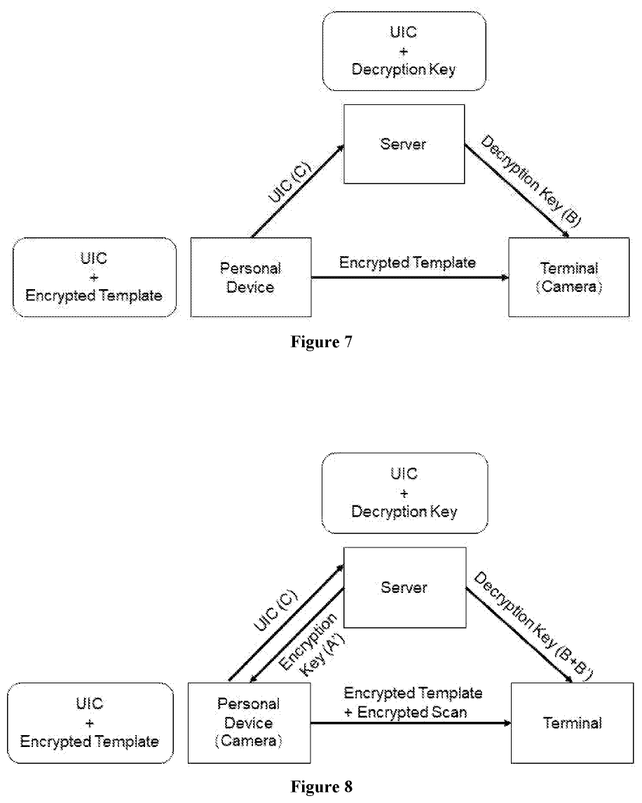

Authentication workflow embodiment one, the biometric template is captured using the camera of the terminal, matching is performed in the terminal, the encrypted template is stored in the personal device, the decryption key is stored in the server. The detailed steps are as follows (FIG. 7):

Step 1: the personal device establishes connections to the terminal and server.

Step 2: the personal device sends the encrypted template to the terminal device directly or through the server.

Step 3: the personal device sends UIC C to the server directly or through the terminal device.

Step 4: the server uses UIC C to locate the decryption key B, and sends the decryption key B to the terminal.

Step 5: the terminal decrypts the encrypted template using B.

Step 6: the terminal uses the camera to capture a biometric scan of the user, then performs identity verification by matching the scan with the decrypted template.

Step 7: the terminal deletes the decryption key, encrypted template, decrypted template, biometric scan, and proceeds to the following procedures based on the matching result.

In this embodiment, when the communication between the terminal and the server is secure, for instance the two are in the same device or in the same secure intranet, the terminal can send the biometric scan to the server, the server can then perform matching and send the result back to the terminal.

In this embodiment, the terminal is the capture module as well as the matching module. The personal device is the template module. The server is the key module. Similarly, multiple modules may be in the same device in other embodiments. While the overlapped modules may be different and the mappings between the logical modules and physical devices may change, such variances will not be elaborated in the rest of this article.

In the setup above, the encrypted biometric template and the decryption key are stored separately in different devices. For example, the encrypted template is stored in the personal device and the decrypted key is stored in the bank server. When an identity verification is requested, the terminal device must acquire both the encrypted template from the personal device and the decryption key from the server. In this way, the system realizes separate storage and double authentication. Moreover, the matching process is performed on a terminal other than the server and the personal device, and the user can select which terminal device to use (for example, select an ATM to withdraw money). Finally, after the completion of biometric authentication, the biometric scan, templates and decryption key will be deleted immediately from the terminal.

Authentication workflow embodiment two, the biometric template is captured using the camera of the personal device, matching is performed in the terminal, the encrypted template is stored in the personal device, the decryption key is stored in the server. The detailed steps are as follows (FIG. 8):

Step 1: the personal device establishes connections to the terminal and server.

Step 2: the personal device sends the encrypted template to the terminal directly or through the server.

Step 3: the personal device sends UIC C to the server directly or through the terminal device.

Step 4: the server uses UIC C to locate the decryption key B, and sends the decryption key B to the terminal.

Step 5: the server generates a new pair of asymmetric keys, the new encryption key A′ and new decryption key B′.

Step 6: the server sends the new encryption key A′ to the personal device and the new decryption key B′ to the terminal.

Step 7: the user uses the camera of the personal device to capture a biometric scan.

Step 8: the personal device encrypts the biometric scan using A′ and sends the encrypted scan to the terminal directly or through the server.

Step 9: the terminal device uses the decryption key B to decrypt the encrypted template and the new decryption key B′ to decrypt the encrypted scan, then matches the two.

Step 10: the terminal deletes the decryption keys B and B′, encrypted template, decrypted template, encrypted scan, decrypted scan and proceeds to the following procedures based on the matching result.

In this embodiment, when the communication between the terminal and the server is secure, for instance the two are in the same device or in the same secure intranet, the terminal can send the biometric scan to the server, the server can then perform matching and send the result back to the terminal.

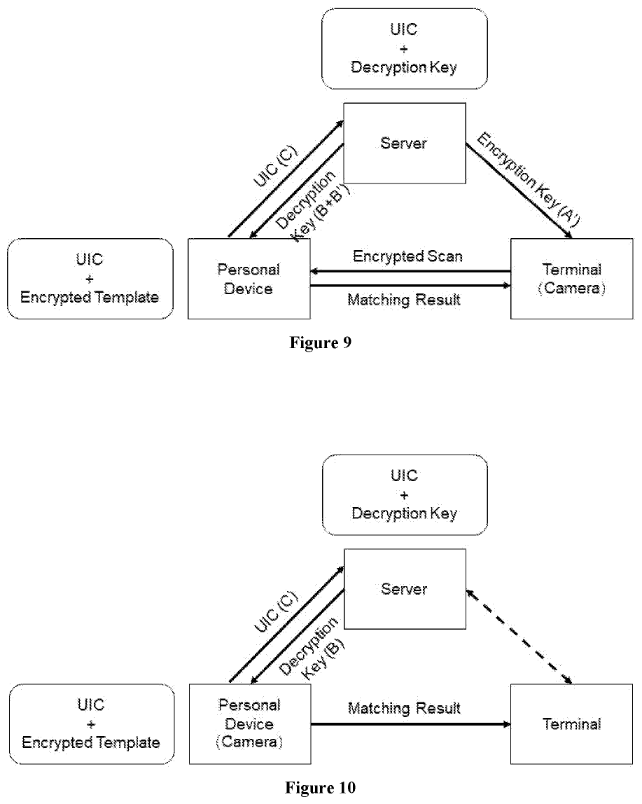

Authentication workflow embodiment three, the biometric template is captured using the camera of the terminal, matching is performed in the personal device, the encrypted template is stored in the personal device, the decryption key is stored in the server. The detailed steps are as follows (FIG. 9):

Step 1: the personal device establishes connections to the terminal and server.

Step 2: the personal device sends UIC C to the server directly or through the terminal.

Step 3: the server uses UIC C to locate the decryption key B, and sends the decryption key B to the personal device.

Step 4: the server generates a new pair of asymmetric keys, the new encryption key A′ and new decryption key B′.

Step 5: the server sends the new encryption key A′ to the terminal and the new decryption key B′ to the personal device.

Step 6: the user uses the camera of the terminal to capture a biometric scan.

Step 7: the personal device encrypts the biometric scan using A′ and sends the encrypted scan to the personal device directly or through the server.

Step 8: the personal device uses the decryption key B to decrypt the encrypted template and the new decryption key B′ to decrypt the encrypted scan, then matches the two.

Step 9: the personal device sends the matching result to the terminal directly or through the server, deletes the decryption keys, encrypted template, decrypted template, encrypted scan, decrypted scan and only keeps the UIC and the encrypted template.

Step 10: the terminal proceeds to the following procedures based on the matching result.

Authentication workflow embodiment four, the biometric template is captured using the camera of the personal device, matching is performed in the personal device, the encrypted template is stored in the personal device, the decryption key is stored in the server. The detailed steps are as follows (FIG. 10):

Step 1: the personal device establishes connections to the terminal and server.

Step 2: the personal device sends UIC C to the server directly or through the terminal.

Step 3: the server uses UIC C to locate the decryption key B, and sends the decryption key B to the personal device directly or through the terminal.

Step 4: the personal device uses decryption key B to decrypt the encrypted template.

Step 5: the personal device uses the camera to capture a biometric scan of the user, then performs identity verification by matching the scan with the decrypted template.

Step 6: the personal device sends the matching result to the terminal directly or through the server, deletes the decryption key B, decrypted template, captured biometric scan, and only keeps the UIC and the encrypted template.

Step 7: the terminal proceeds to the following procedures based on the matching result.

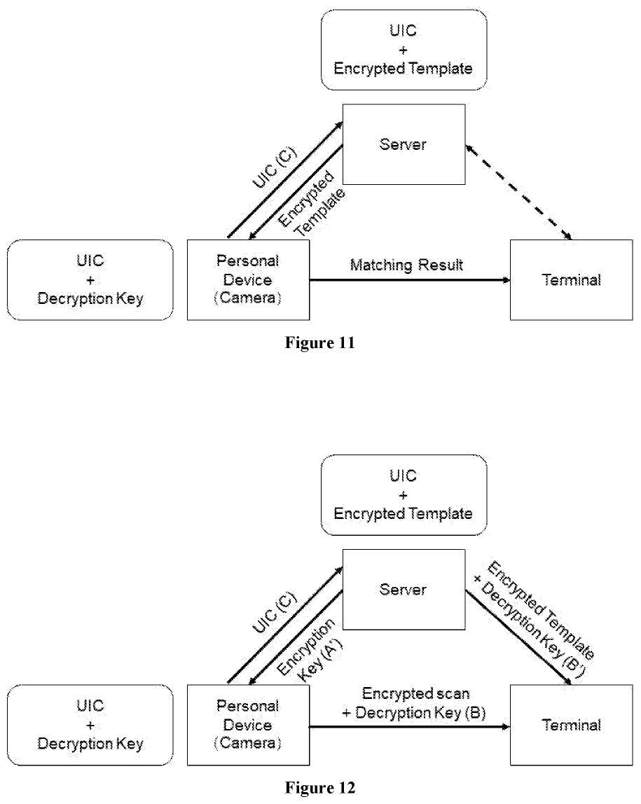

Authentication workflow embodiment five, the biometric template is captured using the camera of the personal device, matching is performed in the personal device, the encrypted template is stored in the server, the decryption key is stored in the personal device. The detailed steps are as follows (FIG. 11):

Step 1: the personal device establishes connections to the terminal and server.

Step 2: the personal device sends UIC C to the server directly or through the terminal.

Step 3: the server uses UIC C to locate the encrypted template, and sends it to the personal device directly or through the terminal.

Step 4: the personal device uses decryption key B to decrypt the encrypted template.

Step 5: the personal device uses the camera to capture a biometric scan of the user, then performs identity verification by matching the scan with the decrypted template.

Step 6: the personal device sends the matching result to the terminal directly or through the server, deletes the encrypted template, decrypted template, captured biometric scan, and only keeps the UIC and the decryption key B.

Step 7: the terminal proceeds to the following procedures based on the matching result.

Authentication workflow embodiment six, the biometric template is captured using the camera of the personal device, matching is performed in the terminal, the encrypted template is stored in the server, the decryption key is stored in the personal device. The detailed steps are as follows (FIG. 12):

Step 1: the personal device establishes connections to the terminal and server.

Step 2: the personal device sends UIC C to the server directly or through the terminal.

Step 3: the server uses UIC C to locate the encrypted template, and sends the encrypted template to the terminal.

Step 4: the server generates a new pair of asymmetric keys, the new encryption key A′ and new decryption key B′.

Step 5: the server sends the new encryption key A′ to the personal device and the new decryption key B′ to the terminal.

Step 6: the personal device captures a biometric scan using the camera.

Step 7: the personal device encrypts the biometric scan using A′ and sends the encrypted scan and the decryption key B to the terminal directly or through the server.

Step 8: the terminal device uses the decryption key B to decrypt the encrypted template and the new decryption key B′ to decrypt the encrypted scan, then matches the two.

Step 9: the terminal deletes the decryption keys B and B′, encrypted template, decrypted template, encrypted scan, decrypted scan and proceeds to the following procedures based on the matching result.

In this embodiment, when the communication between the terminal and the server is secure, for instance the two are in the same device or in the same secure intranet, the terminal can send the biometric scan to the server, the server can then perform matching and send the result back to the terminal.

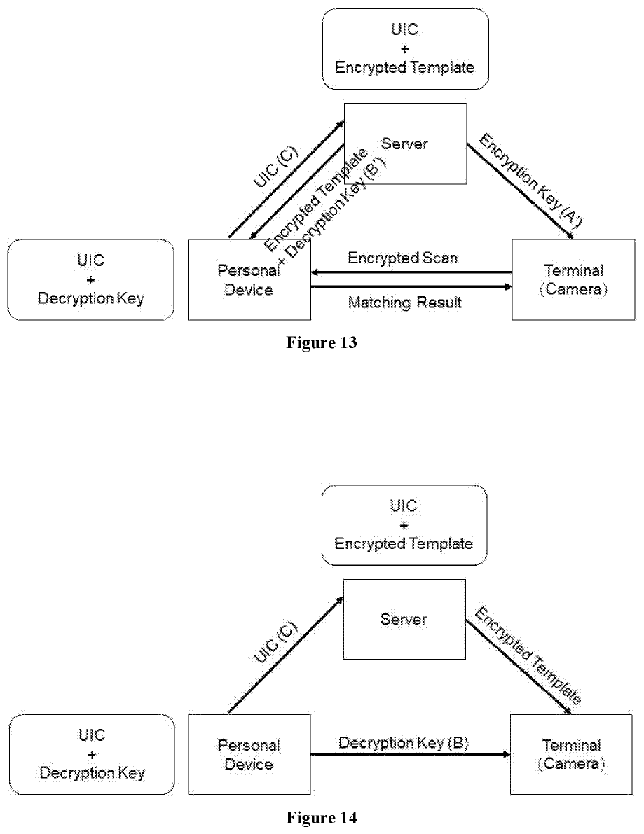

Authentication workflow embodiment seven, the biometric template is captured using the camera of the terminal, matching is performed in the personal device, the encrypted template is stored in the server, the decryption key is stored in the personal device. The detailed steps are as follows (FIG. 13):

Step 1: the personal device establishes connections to the terminal and server.

Step 2: the personal device sends UIC C to the server directly or through the terminal.

Step 3: the server uses UIC C to locate the encrypted template, and sends it to the personal device.

Step 4: the server generates a new pair of asymmetric keys, the new encryption key A′ and new decryption key B′.

Step 5: the server sends the new encryption key A′ to the terminal and the new decryption key B′ to the personal device.

Step 6: the user uses the camera of the terminal to capture a biometric scan.

Step 7: the terminal encrypts the biometric scan using A′ and sends the encrypted scan to the personal device directly or through the server.

Step 8: the personal device uses the decryption key B to decrypt the encrypted template and the new decryption key B′ to decrypt the encrypted scan, then matches the two.

Step 9: the personal device sends the matching result to the terminal directly or through the server, deletes the decryption key B′, encrypted template, decrypted template, encrypted scan, decrypted scan and only keeps the UIC the decryption key B.

Step 10: the terminal proceeds to the following procedures based on the matching result.

Authentication workflow embodiment eight, the biometric template is captured using the camera of the terminal, matching is performed in the terminal, the encrypted template is stored in the server, the decryption key is stored in the personal device. The detailed steps are as follows (FIG. 14):

Step 1: the personal device establishes connections to the terminal and server.

Step 2: the personal device sends the decryption key B to the terminal device directly or through the server.

Step 3: the personal device sends UIC C to the server directly or through the terminal device.

Step 4: the server uses UIC C to locate the encrypted template and sends it to the terminal.

Step 5: the terminal uses decryption key B to decrypt the encrypted template.

Step 6: the terminal uses the camera to capture a biometric scan of the user, then performs identity verification by matching the scan with the decrypted template.

Step 7: the terminal deletes the decryption key B, encrypted template, decrypted template, the captured biometric scan, and proceeds to the following procedures based on the matching result.

In this embodiment, when the communication between the terminal and the server is secure, for instance the two are in the same device or in the same secure intranet, the terminal can send the biometric scan to the server, the server can then perform matching and send the result back to the terminal.

While certain embodiments of the invention have been described herein in detail for purposes of clarity and understanding, the foregoing description and figures merely explain and illustrate the present invention and the present invention is not limited thereto. It will be appreciated that those skilled in the art, having the present disclosure before them, will be able to make modifications and variations to that disclosed herein without departing from the scope of the invention or appended claims.

1. A system for biometric authentication comprising:
a template module and a key module that are independent of each other;
wherein the template module stores encrypted biometric templates generated by encrypting biometric templates using encryption keys; and
the key module stores the decryption keys that can be used to decrypt the encrypted biometric templates.

2. The system of claim 1, wherein the template module is a personal device or a server, accordingly, the key module is the other device of the personal device and the server.

3. The system of claim 1, further comprising a capture module, wherein the capture module can be a personal device or a terminal connected to a server.

4. The system of claim 1, further comprising a matching module and a capture module, wherein:
the matching module matches previously registered biometric template(s) with a captured biometric scan;
the matching module acquires the decryption key from the key module and the encrypted template from the template module, then decrypts the encrypted template using the decryption key to recover the original biometric template; and
the matching module also acquires the biometric scan from the capture module.

5. The system of claim 4, wherein the matching module is a personal device, a server or a terminal.

6. The system of claim 3, wherein the capture module and the template module are in a common device, or the capture module and the key module are in a common device.

7. The system of claim 4, wherein the matching module and the template module are in a common device, or the matching module and the key module are in a common device.

8. The system of claim 4, wherein the matching module and the capture module are in a common device.

9. A method for biometric authentication registration applied to a system comprised of a template module and a key module that are independent of each other, wherein the template module stores encrypted biometric templates generated by encrypting biometric templates using encryption keys, and the key module stores the decryption keys that can be used to decrypt the encrypted biometric templates, the method for biometric authentication registration comprising the steps of:
establishing a connection between the template module and the key module, wherein a pair of encryption and decryption keys and a unique identification code (UIC) are generated by the template module or the key module;
creating and encrypting a biometric template is created using the encryption key, wherein the encrypted template corresponds one to one with the UIC; and
storing the encrypted template and the UIC in the template module, where the decryption key and the UIC are stored in the key module, and all other information is deleted from all modules.

10. The method of claim 9, wherein the UIC is generated as a function of the encrypted template such that the encrypted template corresponds one to one with the UIC.

11. The method of claim 9, wherein the UIC is the same as the encryption key.

12. The method of claim 9, wherein data transmission among modules is secured using asymmetric encryption.

13. A method for biometric authentication in a system comprised of a template module storing encrypted biometric templates generated by encrypting biometric templates using encryption keys, a key module storing decryption keys that can be used to decrypt the encrypted biometric templates, and a matching module that matches previously registered biometric template(s) with a captured biometric scan, the method comprising:
establishing connections amongst the capture module, the matching module, the template module and the key module;
capturing a biometric scan by the capture module, whereby the template module uses a unique identification code (UIC) to locate the to-be-matched encrypted template, and the key module uses the UIC to locate the decryption key of the to-be-matched encrypted template;
acquiring, by the matching module, the encrypted template from the template module, the decryption key from the key module, and the biometric scan from the capture module, where the matching module uses the decryption key to decrypt the encrypted template, matches the decrypted template with the biometric scan, then sends the matching result to the terminal; and
deleting all information regarding the authentication from all of said modules after matching is finished, other than the encrypted template and the UIC which are stored in the template module, and the decryption key and the UIC which are stored in the key module.

14. A method of claim 13, wherein the data transmission amongst the template module, key module and matching module is secured using asymmetric encryption.

15. A method of claim 13, wherein the captured biometric scan is a biometric image or a biometric encoding.

16. The method for biometric authentication registration of claim 9, wherein the biometrics template comprises one or more of: (1) palmprint, (2) face, (3) eye pattern and (4) iris.

17. A method for biometric authentication in a system comprised of a template module storing encrypted biometric templates generated by encrypting biometric templates using encryption keys, a key module storing decryption keys that can be used to decrypt the encrypted biometric templates, and a matching module that matches previously registered biometric template(s) with a captured biometric scan, comprising:
generating, by the key module, a pair of encryption and decryption keys and a UIC;
sending, by the key module, the UIC to the template module, and the encryption key to the capture module directly or through the template module;
by the capture module, capturing a biometric scan, creating a biometric template, and encrypting the template using the encryption key;
sending the encrypted template from the capture module to the template module; and
storing the UIC and the encrypted template by the template module, storing the UIC and the decryption key by the key module, and deleting all other information from all modules.

18. The method of claim 17, wherein the capture module and the template module are in the same device.

19. The method of claim 17, wherein the capture module and the key module are in the same device.

20. A method for biometric authentication in a system comprised of a template module storing encrypted biometric templates generated by encrypting biometric templates using encryption keys, a key module storing decryption keys that can be used to decrypt the encrypted biometric templates, and a matching module that matches previously registered biometric template(s) with a captured biometric scan, comprising:
sending a unique identification code (UIC) from the personal device to the server, wherein: if the template module is in the personal device and the key module is in the server, the UIC is used to locate the decryption key in the server; and if the key module is in the personal device and the template module is in the server, the UIC is used to locate the encrypted template in the server;
sending the encrypted template from the template module to the matching module, and sending the decryption key from the key module to the matching module;
decrypting the encrypted template by the matching module using the decryption key;
capturing a biometric scan by the capture module and sending the biometric scan from the capture module to the matching module;
performing authentication by the matching module, by matching the decrypted template with the biometric scan;
sending the matching result from the matching module to the terminal; and
deleting, by the matching module, data received from said other modules.

21. A method of claim 20, wherein the capture module is in the same device as the template module or the key module.

22. A method of claim 20, wherein the matching module is in the same device as the template module or the key module.

23. A method of claim 20, wherein the matching module is in the same device as the capture module.

24. The method of claim 20, wherein the step of capturing a biometric scan comprises:
generating a second pair of encryption and decryption keys for the secure transmission of the captured biometric scan;
sending the second encryption key to the capture module and the matching module;
encrypting the biometric scan by the capture module using the second encryption key, then sending the encrypted scan to the matching module; and
decrypting the encrypted scan by the matching module using the second decryption key to recover the biometric scan.

25. The method of claim 13, in which the biometric scan comprises one or more of: palm print, face, eye pattern, and iris.
